(19) United States
(12) Patent Application Publication
(10) Pub. No.: US 2013/0159625 A1
(43) Pub. Date: Jun. 20, 2013

(54) INFORMATION PROCESSING DEVICE AND INFORMATION PROCESSING METHOD

(71) Applicant: Hanno Lieske, Tokyo (JP)

(72) Inventor: Hanno Lieske, Tokyo (JP)

(21) Appl. No.: 13/817,811

(22) PCT Filed: Sep. 6, 2010
(86) PCT No.: PCT/JP2010/065684

§ 371 Date: Feb. 19, 2013

(51) Int. Cl. G06F 12/08; G06F 12/02

(52) U.S. Cl. CPC G06F 12/08; G06F 12/02
USPC 711/118; 711/165

(57) ABSTRACT

An information processing device includes an internal memory which is capable of performing processing faster than an external memory, and a memory controller which controls data transfer between the internal memory and the external memory. The memory controller controls a first data transfer and a second data transfer. The first data transfer is a data transfer from the external memory to the internal memory, and the second data transfer is a data transfer from the internal memory to the external memory. The second data transfer transfers a part of the data area of the internal memory transferred in the first data transfer, and the data area which is read out in a non-continuous way from the internal memory is transferred in place to the external memory in the second data transfer.

### TECHNICAL FIELD

This invention relates to an information processing device and method, and particularly to an information processing device and method which perform ROI (Region-of-interest) data transfer between a cache memory and a memory.

### BACKGROUND ART

In video and image processing areas, it is required to process images which are stored in large sized external memory. On the other hand, during the processing step, the data is required to be available in an internal memory. Therefore, the large image needs to be partitioned in to smaller portions. In the video and image processing areas, a partitioned area mainly used is a macro block (MB) with 16 times 16 pixels. Before processing an MB, the data is transferred from external to internal memory area, and after processing the MB, the data is stored back from internal to external memory area. On the internal side, cache areas can be used which includes a copy of a part of the image stored in the memory area.

A first related art to perform the required data transfer before and after processing of an MB is, to utilize the existing cache replacement method (patent literature 1).

Here, data which is requested but not available in the cache area is loaded from the memory area. When the cache area is full, parts of the cache area, also called cache lines, are stored in-place back before the new data is loaded. FIG. 8 shows an example of the data transfer request of an MB 401 between a memory area 400 and a cache area 410 using the cache replacement method. Here, enough cache lines 411 in the cache area are available to load the MB data. In this example, the horizontal picture size in pixel 402 should be larger than the amount of pixel 403 in the external memory with a size equal to one cache line in the cache area.

In this case, each pixel row of the MB is transferred by a separate data transfer request into different cache lines. Here, for a ROI data read transfer 421 as well as a ROI data write transfer 422, 16 cache lines are transferred between the memory area and the cache area. Because the cache line size is normally larger than the MB width of 16 pixels which correspond to 16 bytes, more data has to be transferred than necessary.

In a second related art to transfer the MB data, the region of interest (ROI) data area transfer available in the patent literature 2 is utilized, which prevents this problem in a transfer of an MB. FIG. 9 shows an example of ROI data read and write transfers between a cache area and a memory area of the patent literature 2. Here, a two-dimensional ROI data area 501 in the memory area 500 is defined by a start address a, a horizontal size 502, and a vertical size 503 and an offset between two neighboring rows 504 corresponding to the distance between row 1 505 and row 2 506 as shown in FIG. 9. On a cache area side 510, a ROI data area 511 is stored in a continuous way starting from a defined start address b with row 1 512 till row 16 513. Here, for a ROI data read transfer 521 as well as a ROI data write transfer 522, an MB of only 256 bytes (16 times 16 pixels) are transferred between the memory area and the cache area without any additional data required to be transferred.

The ROI data transfer of the patent literature 2, which transfers data between the memory area and the cache area, accesses the cache area only in a continuous way. As result, the ROI data transfer of the patent literature 2 produces unnecessary data transfers and requires an increased data bandwidth and data transfer time if only a non-continuous part of this data needs to be transferred Note that the non-continuous part consists of areas of the same size which have to be transferred separated by areas of the same size which need not have to be transferred.

FIG. 10 shows the required ROI data transfer tasks for an H.264 intra prediction process for the patent literature 2 in more detail. For a ROI data read transfer 621, the transfer start address is set to the first pixel of a first data row 602 of the requested data field in a memory area 600 which corresponds to the upper left pixel in a two-dimensional ROI data area 601. For the following data row 2 603, the start address is calculated by adding to the current start address a the number of bytes which is transferred 604 and a given memory_area_offset 605 which specifies the number of skipped bytes between the current row and the following row.

Further on, the number of data rows to be transferred 606 is specified. On the cache side, only a transfer start address b inside the cache area 610 is specified. For the transfer of the following data rows from the memory area, the data is stored inside the cache area in a continuous way. After finishing the H.264 intra prediction process on the MB, to store the new processed MB data back to memory, in the patent literature 2, the same ROI data transfer request parameter as used in the ROI data read transfer can be taken for the ROI data write transfer 622. Thus, 17 burst 4 (burst 4 is a transfer of 32 bytes per request in four clock cycles) write transfers are executed to store in the ROI area 611 in the cache area back to the memory area starting from point c.

Alternatively, also a ROI data write transfer can be scheduled which only write back 16 data rows of the ROI data area 611 in the cache area with each having 32 bytes by scheduling 16 burst 4 transfers. In this case, data transfer starts with the data of the second data row 612 in the cache area and ends with the data of the 17th data row 613.

This is possible because the data of the first data row is only read but not modified. Thus the correct data values are still stored inside the memory area.

First, the start addresses in the memory area c and in the cache area b have to be set to the first pixel of the second data row, and second, the number of data rows to be transferred has to be changed from 17 to 16. Then, only 16 rows from the cache area 611 are transferred to the memory area and stored in the 16 rows 632 with each 32 pixel width 631 starting from the second row.

FIG. 11 shows a ROI data transfer unit for the patent literature 2. A ROI data transfer unit 700 includes a read/write selection unit 701 , a memory area start address set unit 702, a cache area start address set unit 703, a ROI data area width unit 704, a ROI data area height unit 705, a memory area offset unit 706, and a transfer execution unit 707. The read/write selection unit 701 firstly sets the correct transfer direction, and secondly, selects the correct path for data transfer, which is either from the memory area to the cache area or from the cache area to the memory area. The memory area start address set unit 702 initializes at the beginning the memory area start address to the first pixel of the first row of the ROI data area used in the transfer.

The cache area start address set unit 703 initializes at the beginning the cache area start address to the upper left position of the ROI data area in the cache area. The ROI data area width unit 704 firstly initializes the ROI data area width parameter. Secondly, the ROI data area width unit 704 updates the addresses for the next row to be transferred in the memory area and cache area by adding for each row the ROI data area width to the addresses. The ROI data area height unit 705 firstly initializes the ROI data area height parameter. Secondly, the ROI data area height unit 705 decrements the height and compares the height with zero, by using a loop counter.

The memory area offset unit 706 firstly initializes the memory_area_offset parameter. Secondly, the memory area offset unit 706 updates the memory area address of the next row to be transferred by adding the offset value to the memory area address. The transfer execution unit 707 controls the ROI data transfer process by calling the tasks of the other apparatuses. The control flow for the patent literature 2 is shown in FIG. 12.

The controlling of the ROI data area transfer is done by the transfer execution control task of the transfer execution unit 707. Firstly, the ROI data area transfer initialization is done by executing: memory area initialization task of the memory area start address set unit 702, the cache area initialization task of the cache area start address set unit 703, the ROI data area width initialization task of the ROI data area width unit 704, the ROI data area height initialization task of the ROI data area height unit 705, the memory area offset initialization task of the memory area offset unit 706 and the transfer direction set task of the read/write selection unit 707 (step S21).

Next, the ROI data area height compare task of the ROI data area height unit 705 compares the height with zero by using a loop counter (step S22). If the height reaches zero, the ROI data transfer is completed (step S22: Yes). If the height does not reach zero (step S22: No), the read/write selection unit 701 selects the correct transfer path (step S23). If the transfer is read transfer, ROI data bytes are transferred from the external memory (memory area) to the cache memory (cache area) (step S24). If the transfer is write transfer, ROI data bytes are transferred from the cache area to the memory area (step S25). Then, the memory area address update task from the ROI data area width unit 704 is called, which adds the width to the memory area address (step S26), followed by the memory area address update II task from the memory area offset unit 706, which adds the memory_area_offset to the memory area address updated in S26 (step S27). Then the cache area address update task from the ROI data area width unit 704 is called, which adds the width to the cache area address (step S28). Finally, the ROI data area height decrement task of the ROI data area height unit 705 decrements the ROI data area height variable by 1 (step S29).

### CITATION LIST

### Patent Literature

PTL 1: U.S. Pat. No. 5,737,752

PTL 2: A. Prengler and K. Adi, “A Reconfigurable SIMD-MIMD Processor Architecture for Embedded Vision Processing

### SUMMARY OF INVENTION

### Technical Problem

However, there is the problem that the necessary data transfer time for transferring non continuous data fields cannot be reduced in the methods of the patent literatures 1 and 2, because the data can be only accessed continuously in the internal memory.

### Solution to Problem

Therefore, the present invention has been made to solve this problem, and it is an object of the present invention to provide an information processing device and data transfer method which can reduce the necessary data transfer time for transferring non continuous data fields between an external memory and an internal memory.

According to an exemplary aspect of the invention there is provided an information processing device including an internal memory which is capable of performing processing faster than an external memory, and a memory controller which controls data transfers between the internal memory and the external memory. The memory controller controls a first data transfer and a second data transfer. The first data transfer is a data transfer from the external memory to the internal memory, and the second data transfer is a data transfer from the internal memory to the external memory. The second data transfer transfers only a part of the amount of data transferred in the first data transfer, the data is read out from a non-continuous area of the internal memory and transferred to the external memory in the second data transfer.

According to another exemplary aspect of the invention there is provided a data transfer method transferring data between an external memory and an internal memory. The internal memory is capable of performing a data transfer process faster than the external memory. The method includes (a) writing data to the internal memory from the external memory by a first data transfer, and (b) writing back data to the external memory from the internal memory by a second data transfer. A part of data of the first data transfer is transferred in the second data transfer, and the second data transfer is a data transfer process from a non-continuous area of the internal memory to the external memory.

### Advantageous Effects of Invention

According to the present invention, an information processing device and data transfer method which reduces the transfer time which is needed for the data transfer can be provided.

### BRIEF DESCRIPTION OF DRAWINGS

FIG. 1 is a view showing an information processing device of a first exemplary embodiment of the present invention.

FIG. 2 is a view showing an external memory and a cache memory.

FIG. 3 is a flow chart showing ROI data read transfer of the first exemplary embodiment of the present invention.

FIG. 4 is a flow chart showing ROI data write transfer of the first exemplary embodiment of the present invention.

FIG. 5 is a view showing an external memory and an internal memory of a second exemplary embodiment.

FIG. 6 is a view showing a ROI data transfer apparatus for a third exemplary embodiment of the present invention.

FIG. 7 is a view showing a cache area offset unit of the third exemplary embodiment of the present invention.

FIG. 8 is a view showing an example of the data transfer request of an MB between a memory area and a cache area using the cache replacement method.

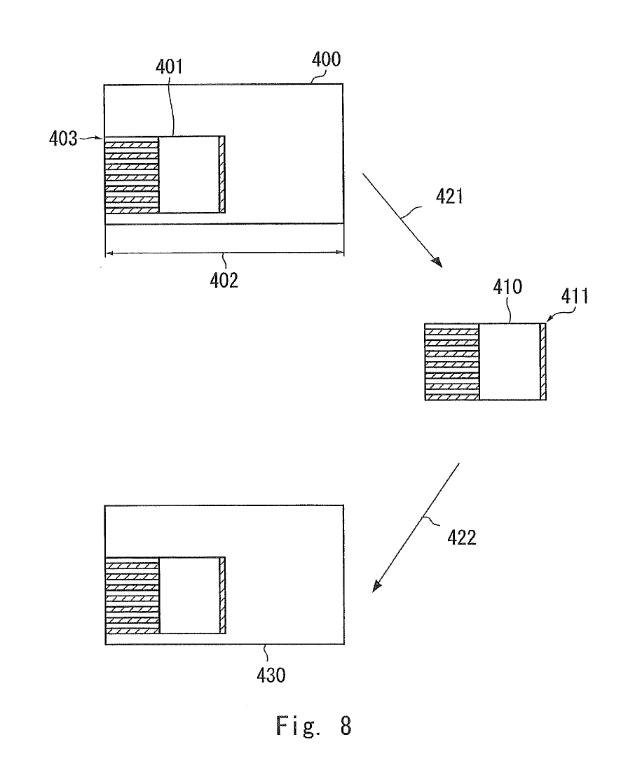

FIG. 9 is a view showing an example of ROI data read and write transfers between a cache area and a memory area of a patent literature 2.

FIG. 10 is a view showing the required ROI data transfer tasks of the patent literature 2 for the H.264 intra prediction process in more detail.

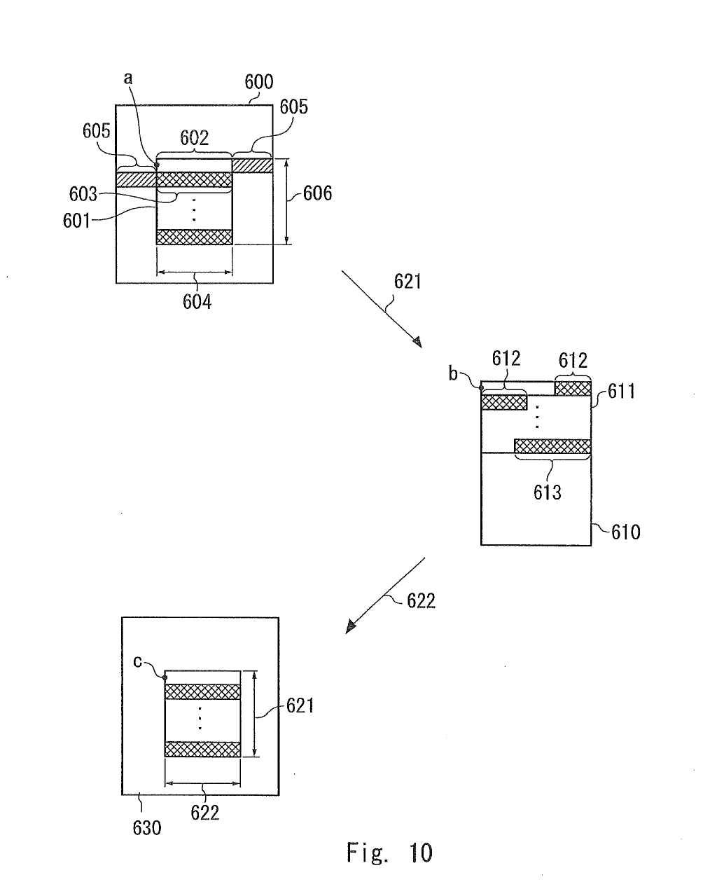

FIG. 11 is a view showing a ROI data transfer unit of the patent literature 2.

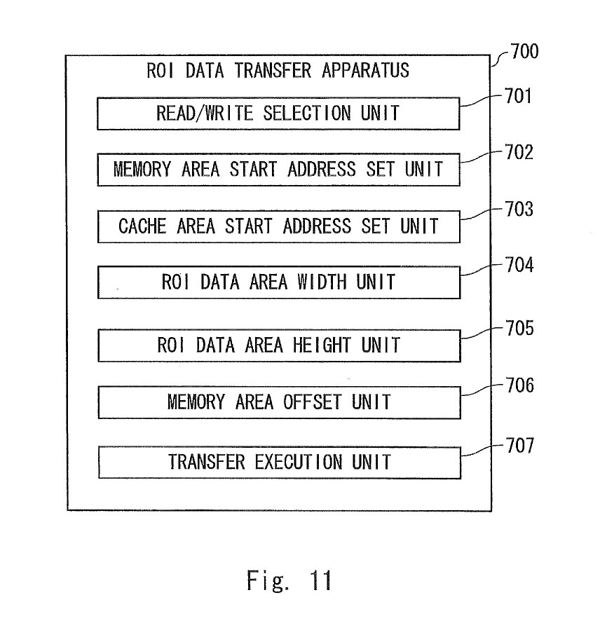

FIG. 12 is a flow chart showing ROI data read transfer and ROI data write transfer of the patent literature 2.

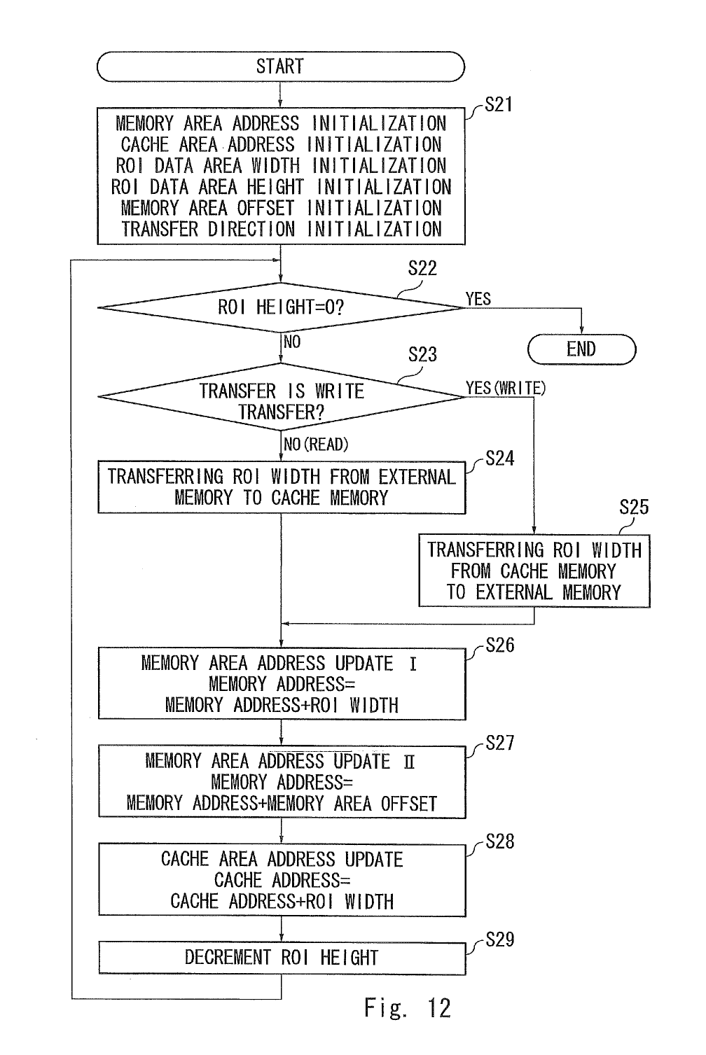

### DESCRIPTION OF EMBODIMENTS

The exemplary embodiment relates to a method and an apparatus for an enhanced region of interest (ROI) data transfer between memory and a cache area. The enhancement is achieved by adding a new ROI data transfer request parameter (cache_area_offset) for the description of the data field for the cache area which specifies an offset between two neighboring data rows of a data field to be transferred. Due to this new ROI data transfer request parameter, a non-continuous data field in the cache area can be specified for the data transfer, which can reduce the amount of data to be transferred and required transfer time as well. This is done by skipping data inside the cache area.

The optimization is done by setting the newly added ROI data transfer parameter “cache_area_offset” equal to the horizontal size difference of the ROI data read and ROI data write transfer requests, which enables the possibility to store a non-continuous data of a data field which has been read in a ROI data read transfer by using the parameter “cache_area_offset” for the ROI data write transfer to skip the data which need not have to be transferred.

Further, compared to the patent literature 1, the overhead of transferring whole cache lines can be reduced. Compared to the patent literature 2 where only a continuous data field in the caches can be defined for the ROI data write transfer, the exemplary embodiment enables to transfer a non-continuous part of the data field. The non-continuous part consists of areas of the same size which have to be transferred separated by areas of the same size which need not have to be transferred.

For a cache area, the user does not have to take care about the data transfer between cache and external memory. This is done by the system. The user is always accessing the data from the cache and if the data is not available, the data is transferred by the system from the external memory to the cache area, so the system takes care about the data consistency.

For the ROI transfer, the user is loading the data from external memory to the cache memory area, which is now not used as cache, but as a scratch memory. At the end, the data is also written back by the user from the scratch memory to the external memory. So here, the user is responsible for any data consistency.

As alternative, when using for the ROI transfer of the cache area, the consistency check of by the ROI data used cache lines in the cache memory is not done, so the cache memory is acting for the ROI transfer like a scratch memory. The difference between this implementation and a real scratch memory is that the cache replacement strategy is also used for the cache lines which are holding the ROI data. Therefore, in case, a cache line which is holding ROI data is selected from the cache replacement algorithm as next cache line to be used for a data cache transfer, the ROI data inside the cache line is temporary stored into external memory and when needed again restored. This storing and restoring is done in background by the system.

### First Exemplary Embodiment

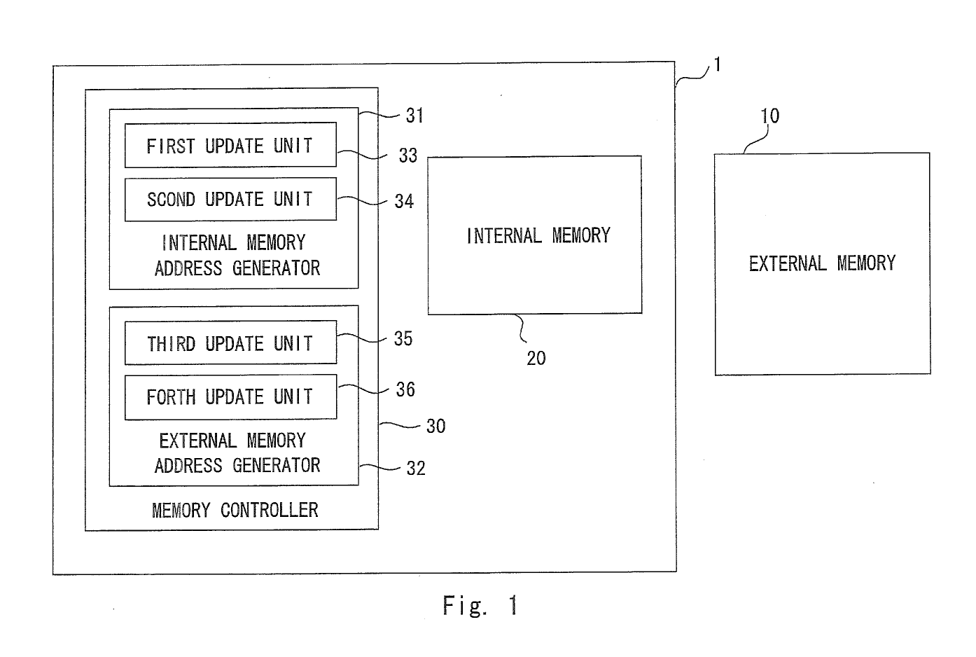

Hereinafter, exemplary embodiments will be explained with reference to drawings. FIG. 1 is a view showing an information processing device of a first exemplary embodiment of the present invention. As shown in FIG. 1, an information processing device 1 includes an internal memory 20 which is capable of performing processing faster than an external memory 10 and a memory controller 30 which controls data transfer between the internal memory 20 and the external memory 10.

The memory controller 30 controls a first data transfer and a second data transfer. The first data transfer is a data transfer from the external memory 10 to the internal memory 20 and the second data transfer is a data transfer from the internal memory 20 to the external memory 10. In the second data transfer, a part of the data field, which was transferred in the first data transfer, is transferred to the external memory 10, the part of the data field is a non-continuous area of the internal memory 20.

In the first data transfer, data is read out from an updated first address of the external memory and is written in an updated second address of the internal memory, and in the second data transfer, data is read out from an updated third address of the internal memory and is written in an updated fourth address of the external memory.

The memory controller 30 includes an internal memory address updating unit 31 which updates a second address and a third address. Data written to the updated second address of the internal memory 20 is continuous data, and data read out from the updated third address of the internal memory 20 is non-continuous in the second data transfer.

Further the memory controller 30 includes an external memory address updating unit 32 which updates a first address and a fourth address. Data started to be read out from the updated first address of the external memory 10 in the first data transfer, and data started to be written back to the updated fourth address of the external memory 10 in the second data transfer.

The internal memory 20 is, for example, a cache memory. Hereinafter, the internal memory 20 will be explained as the cache memory 20. In this exemplary embodiment, a case in which a ROI data stored in the external memory 10 is transferred will be described. The ROI data is transferred from the external memory 10 to the cache memory 20 with a unit of macro block (MB). The information processing device 1 further includes a process circuit (not shown) which performs a predetermined process by using the data written in the internal memory. The ROI data stored in the cache memory 20 is subjected to the predetermined processing such as compression by a processing circuit (not shown) of a subsequent stage. An updated ROI data by the predetermined processing is written back to the external memory 10 again. That is, in the second data transfer, only updated data which is updated by the process circuit is written back to the external memory 10.

The first data transfer in which an MB is transferred from the external memory 10 to the cache memory 20 will be called a ROI data read transfer. Further, the second data transfer in which ROI data updated by the processing circuit is written back to the external memory 10 will be called a ROI data write transfer.

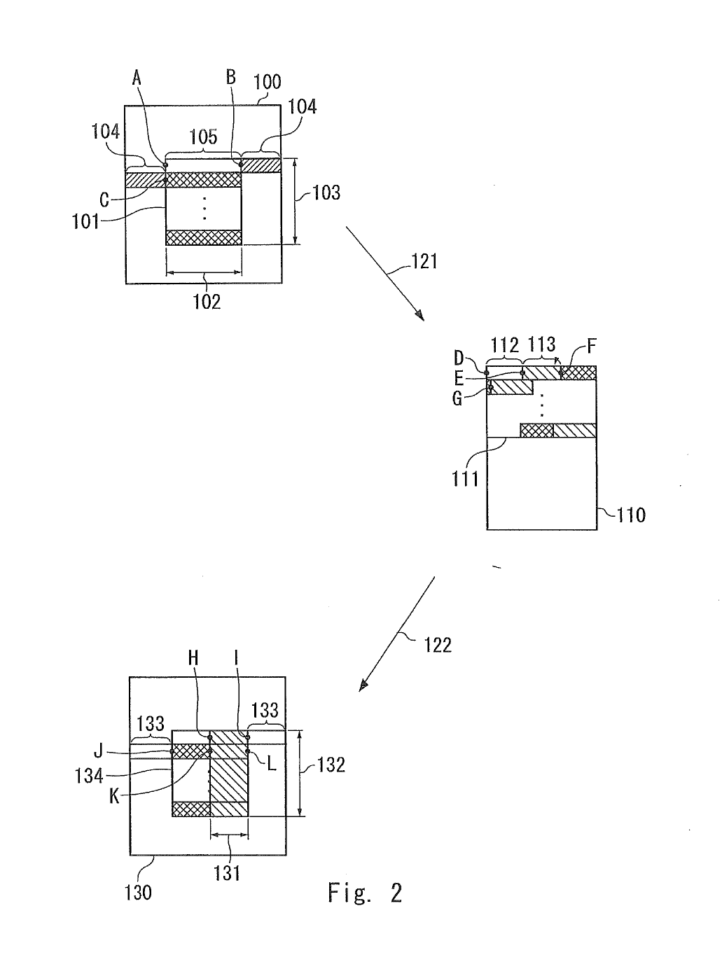

FIG. 2 is a view explaining data structure of the cache memory 20 and the external memory 10. Reference numeral 100 of FIG. 2 shows an external memory area 100 before data transfer, and 130 of FIG. 2 shows an external memory area 100 after data transfer. A data transfer from the external memory 10 to the cache memory 20 is a ROI data read transfer 121, a data transfer from the cache memory 20 to the external memory 10 is a ROI data write transfer 122.

In FIG. 2, reference numeral 101 shows a ROI data area and a macro block (MB) is stored in the ROI data area. A point A shows a start address of MB. A point B shows an end address of a first row of MB. A point C shows a start address of a second row of MB. The MB has the width (ROI width) 102 and the height (ROI height) 103. Further, reference numeral 104 shows a memory_area_offset (a second offset), and indicates a gap between the end address B of the first row of the ROI data and the start address C of the next row. Data 105 shows an MB row, a minimum data unit transferred in the ROI data read transfer.

In FIG. 2, reference numeral 111 shows a ROI data area, and an MB is stored in the ROI data area. However, as is different from the cache memory 20, the MB is stored in a continuous way. The stored ROI data is updated by predetermined processing such as compression by a processing circuit (not shown). This ROI data includes data updated by this processing and data which is not updated. Hereinafter, the data which is not updated will be called non-updated data.

A point D shows a start address of an MB, a point E shows a start address of updated data of a first row of the MB, and a point F shoes an end address of the updated data of the frist row of the MB. A point G shows an end address of non-updated data of the second row. Data 112 is non-updated data of the first row, and data 113 is updated data of the first row. Data 113 is an MB row, a minimum data unit transferred in the ROI data write transfer.

Reference numeral 130 of FIG. 2 shows the external memory 10 similarly to 100 of FIG. 2; however 130 of FIG. 2 shows a state in which data is transferred by ROI data write transfer from the cache memory 20. As described above, an MB in the cache memory 20 includes updated data and non-updated data. In this ROI data write transfer, only the updated data is written back to the external memory 10. That is, since non-updated data among ROI data stored in the cache memory 20 is the same data before the data is written back, data need not be written back. Therefore, in the ROI data write transfer, only updated data is transferred.

In the external memory 10, a point H shows a start address of the ROI data write transfer of a first row in an MB, and a point I shows an end address. A point J shows a start address of non-updated data of a second row, a point K is a start address of the updated data of the second row, and a point L is an end address of the updated data of the second row. The ROI data that is written back has a width 131 and a height 103.

An MB consists of 16*16 pixels (16*16 bytes), so that for the ROI read transfer the ROI width 102 and ROI height 103 are set to 16. On the other hand, the width 131 of the data area which is written back is only 8 bytes, so the ROI width 131 is set to 8 and the ROI height 103 is set to 16 for the ROI write transfer.

Thus, in the ROI data read transfer 121, data of 16 bytes in each row (data 105) is transferred; on the other hand, in the ROI data write transfer 122, data of 8 bytes in each row (data 113) is transferred. The difference of the data amount between the ROI data read transfer and the ROI data write transfer (data 105−data 113) corresponds to the non-updated data 112 shown in FIG. 2, and hereinafter the non-updated data 112 will be called a cache_area_offset (a first offset).

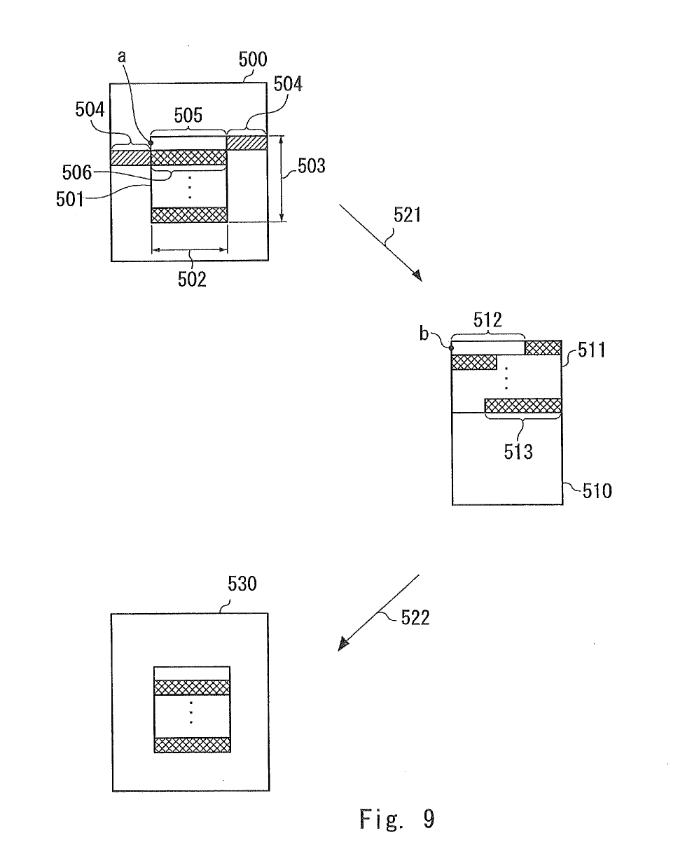

To show the advantage of the exemplary embodiment, the ROI data read transfer and the ROI data write transfer are examined. The ROI data read transfer and the ROI data write transfer have different horizontal sizes as described above. For the ROI data read transfer, the same data field as in FIG. 9 with the same transfer parameter set is read from the memory area to the cache area, while for the ROI data write transfer, only the last 8 bytes of each row of the MB is stored back to the memory area.

There is no difference in processing of the ROI data read transfer between the first exemplary embodiment of the present invention and the patent literature 2 shown in FIG. 9. In both cases, 16 bytes are read per MB row.

For the ROI data write transfer, the patent literature 2 shown in FIG. 9 has to transfer again 16 bytes back from the cache memory to the external memory. This is due to the fact that inside the cache area, only continuously stored data can be accessed, because only the start address of the continuous area is given and no information about a gap inside the continuous area nor a new transfer starting address inside the continuous area are specified. For the ROI data write transfer of the exemplary embodiment, a ROI data transfer request parameter “cache_area_offset” for the cache area description is newly added. This parameter enables to transfer also a non-continuously stored data field from the cache area to the memory area. The non-continuous data field consists of areas of the same size which have to be transferred and areas of the same size which need not have to be transferred. Due to this parameter, the new starting address for the ROI data transfer can be defined. This is done by adding the data_cache_offset to the position which corresponds to the row start address.

In this case, the horizontal size of the areas which have to be transferred is defined by the horizontal size parameter of the ROI data write transfer, while the horizontal size of the areas which need not have to be transferred is defined by the new parameter “cache_area_offset” of the ROI data write transfer. Further on, the addition of these both parameters: the horizontal size of the ROI data write transfer and the cache_area_offset of the ROI data write transfer, matches the horizontal size of the ROI data read transfer.

In the cache area 110, the transferred data is stored as a continuous ROI data area 111 in the same way as in the patent literature 2 shown in FIG. 9. However, when the data is transferred in the ROI data write transfer 122 from the cache area 110 to the memory area 130, it is possible to transfer only the required last 8 pixels 113 and skipping the first 8 pixels 112 while utilizing the new cache parameter “cache_area _offset”. This is done by setting the horizontal size 131 in the ROI data write transfer 122 to the number of pixels which should be transferred, which is 8, and by setting the parameter “cache_area_offset” to the difference of the horizontal size of the ROI data read and ROI data write transfer requests, which is 8 (16−8 pixels) in this example.

Additionally, the start address E in the cache area, and for in-place replacement, the start address II in the memory area 101 have to be adjusted by adding the number of skipped pixels given by the parameter “cache_area_offset”(8) to the start addresses. By performing the ROI data write transfer 122 in the exemplary embodiment, 128 bytes (16×8 pixels) have to be transferred, while for the patent literature 2, 256 bytes (16×16 pixels) have to be transferred. Thus, the bytes to be transferred can be reduced by 128 bytes (16×8 pixels).

Returning to FIG. 1, the memory controller 30 includes the internal memory address updating unit 31 which updates a second address and a third address. The memory controller 30 includes the external memory address updating unit 32 which updates a first and fourth address.

Here, an updated first address is a read address of the external memory 10 of the ROI data read transfer. An updated second address is a write address of the cache memory 20 of ROI data read transfer. An updated third address is a read address of the cache memory 20 of the ROI data write transfer. An updated fourth address is a write address of the external memory 20 of the ROI data write transfer.

The external memory address updating unit 32 includes the third update unit 35 which updates the first address by the first data transfer size (ROI width 1) and generates a first updated first address. The first data transfer size is a size of data transferred from the external memory 10 to the cache memory 20 in the ROI data read transfer. The external memory address updating unit 32 also includes the fourth update unit 36 which updates the first updated first address by using a second offset (memory_area_offset) and generates a second updated first address (updated first address) which is used for the ROI data read transfer.

The internal memory address updating unit 31 includes the first update unit 33 which updates the second address by the ROI width 1 and generates a first updated second address. The internal memory address updating unit 31 also includes the second update unit 34 which is however for the read direction not used, because there exists no cache_area_offset in the continuous area of the ROI read direction.

The first update unit 33 updates the third address by the second data transfer size (ROI width 2), and generates a first updated third address. The second update unit 34 updates the first updated third address by using cache_area_offset and generates a second updated third address (updated third address).

The third update unit 35 updates the fourth address by the second data transfer size (ROI width 2) and generates a first updated fourth address. The second data transfer size is a size of data transferred from the cache memory 10 to the external memory 20 in the ROI data write transfer. The fourth update unit 36 updates the first updated fourth address by using memory_area_offset and cache_area_offset and generates a second updated fourth address (updated fourth address) which is used for the ROI data write transfer.

The predetermined value of read and write pointers for the external memory are increased by memory_area_offset, and the predetermined value of write pointer is additional increased by cache_area_offset.

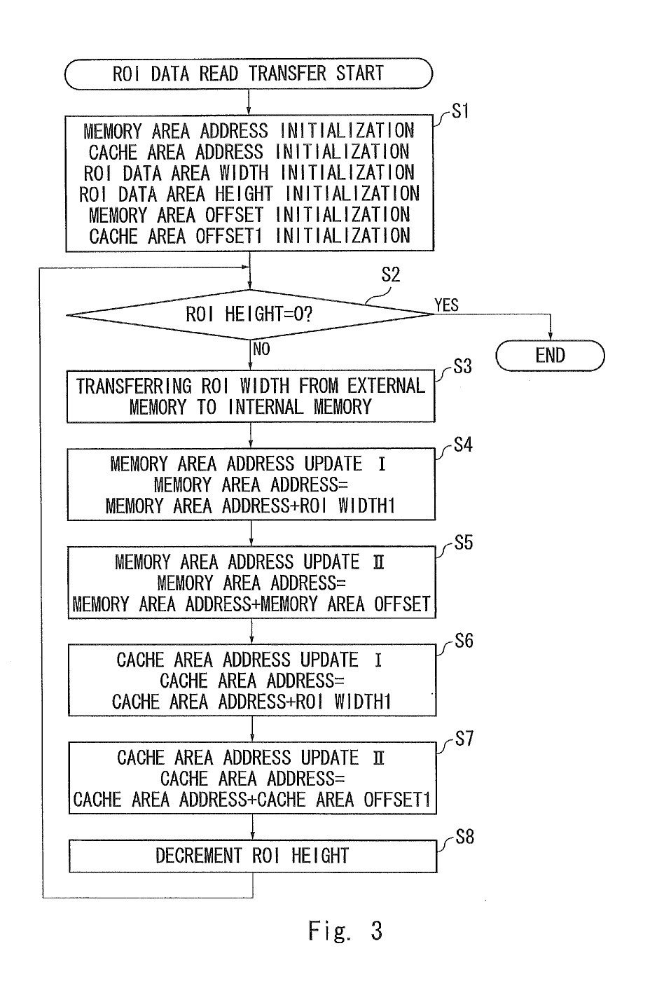

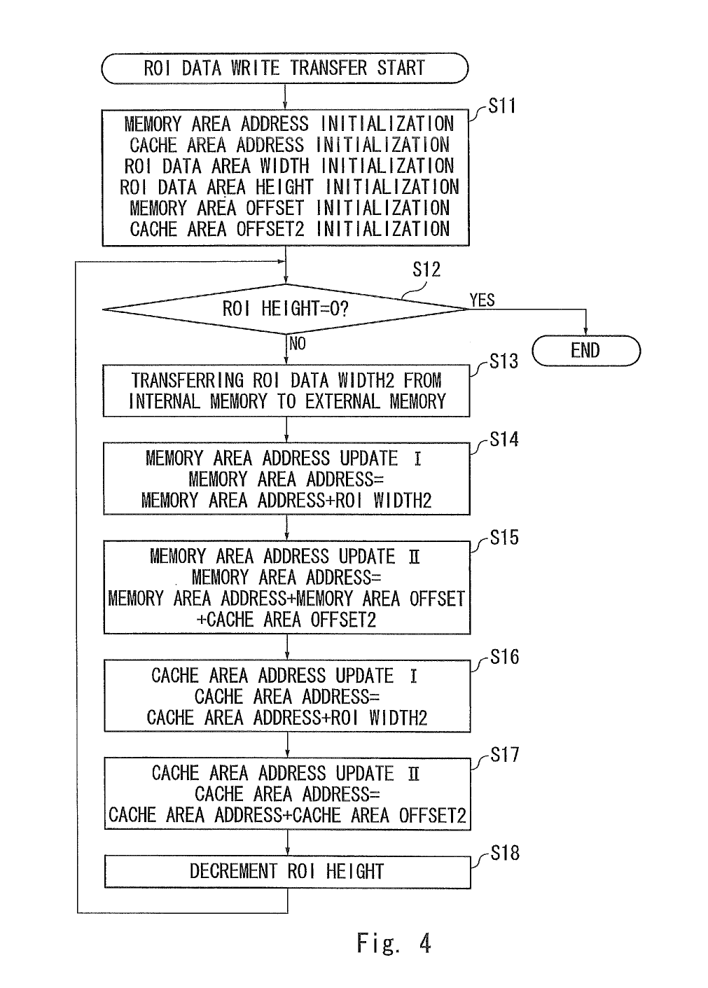

Hereinafter, an operation of the information processing device 1 will be explained in detail. FIG. 3 is a flow chart showing ROI data read transfer of the first exemplary embodiment of the present invention. FIG. 4 is a flow chart showing ROI data write transfer of the first exemplary embodiment of the present invention.

As shown in FIG. 3, first of all, a memory area address, a cache area address, a ROI data width, a ROI data height, and a memory_area_offset are initialized (step Si).

The memory controller 30 reads a row of data from the external memory area starting from the memory area address A of the external memory area 100 and then skips memory_area_offset (104) area bytes. The memory controller 30 then write the read out data to the cache area 110 starting at the cache area start address D.

The memory area address is set to a data read start address (point A) by the initialization. The cache area address is set to a data write start address (point D). The ROI width is set to a ROI width of MB, that is 16 bytes. The ROI height is set to a height of the data region of MB, that is 16 rows. The memory_area_offset is set to a memory_area_offset 104.

Next, whether or not ROI height is zero is determined (step S2). If the ROI height reaches zero, the ROI data read transfer is finished. If the ROI height is not zero, the process proceeds to step S3.

Next, data which has ROI data width is transferred from the external memory area 100 to the cache memory area 110 (step S3). If the transfer is finished, each address is updated. First, the memory area address (a first address) is updated. In a memory area address update I, memory area address is updated as memory area address=memory area address+ROI width (step S4). Next, memory area address update II is performed by adding memory_area_offset to the updated address (step S5). By this, memory area address is updated as follows; transfer start address of MB (point A)→an end address of the MB of a first row (point B)→a transfer start address of the MB a second row (point C). The point C is an updated first address.

Additionally, the cache area address (a second address) is updated as cache area address=cache area address+ROI width (step S6, cache area address update I). By this, cache area address in the cache memory 20 is updated as follows; cache data transfer start address (point D)→an end address of MB of a first row which is equal to a write start address of MB of a second row (point F). The point F is an updated second address. In this way, after updating addresses of the external memory 10 and the cache memory 20, ROI height is decremented (step S7). After that, process from step S2 is repeated until ROI height reaches zero.

Next, ROI data write transfer will be explained. As shown in FIG. 4, in S11 all values are initialized as in S1 shown in FIG. 3. The difference is only that an additional parameter, the cache_area_offset, has to be initialized. Step S12 corresponds to step S2 shown in FIG. 3. Thus, each value is initialized, then processing of step S3 and the subsequent steps are repeated until ROI height reaches zero. Here, the ROI width is different between ROI data read transfer and ROI data write transfer. In ROI data write transfer, the ROI width which corresponds to the transfer size is changed to a smaller value. In this exemplary embodiment, it is set to eight bytes which is a half of the ROI data read transfer, which means that the size of data 113 is equal to ROI width 2. Then the size of data 112 which is not updated (non-updated data) is set to cache_area_offset.

Next, the process proceeds to step S13. Data of ROI width 2 is transferred from the cache memory 20 to the external memory 10 (step S13). Next, similarly to ROI data read transfer, the memory area address and the cache area address are updated.

First of all, the memory area address (a fourth address) is updated by the memory area address+ROI width 2 (step S14, the memory area address update I). Next, memory area address is updated by the memory area address+memory_area_offset+cache_area_offset (step S15, memory area address update II). By this, as shown in FIG. 2, the memory area address is updated as follows; a data write start address (point H)+ROI width 2=point I, point I+the memory_area_offset 104=point J, point J+cache_area_offset=point K. Therefore, when ROI data write transfer of the next row is started, the data is written from the point K. The point K is an updated fourth address.

On the other hand, in the cache memory 20, cache area address (a third address) is updated by cache area address+ROI width 2 (step S16, cache area address update I). Next, the cache area address is updated by cache area address+cache_area_offset (step S17, cache area address update II). In this example shown in FIG. 2, a read start address point E of the cache memory 20+ROI width 2=point F, point F+cache_area_offset=point G, and the updates I, II are performed so that the ROI data write transfer of the second row is started from the point G. The point G is an updated third address.

Further, after updating each address, the ROI height is decremented (step S18), and then the process goes back to step S12. The processing of step S13 and the subsequent steps is repeated until the ROI height reaches zero.

As described above, in the present exemplary embodiment, only updated data among ROI data stored in the cache memory 20 is transferred in the ROI data write transfer, thereby reducing transfer time which is needed for the data transfer.

The patent literatures 1 and 2 do not have specified an internal offset, so they cannot jump over pixels which should not be transferred. On the other side, the present invention has this internal offset specified, so the start addresses of each row in the non-continuous data field can be calculated.

### Second Exemplary Embodiment

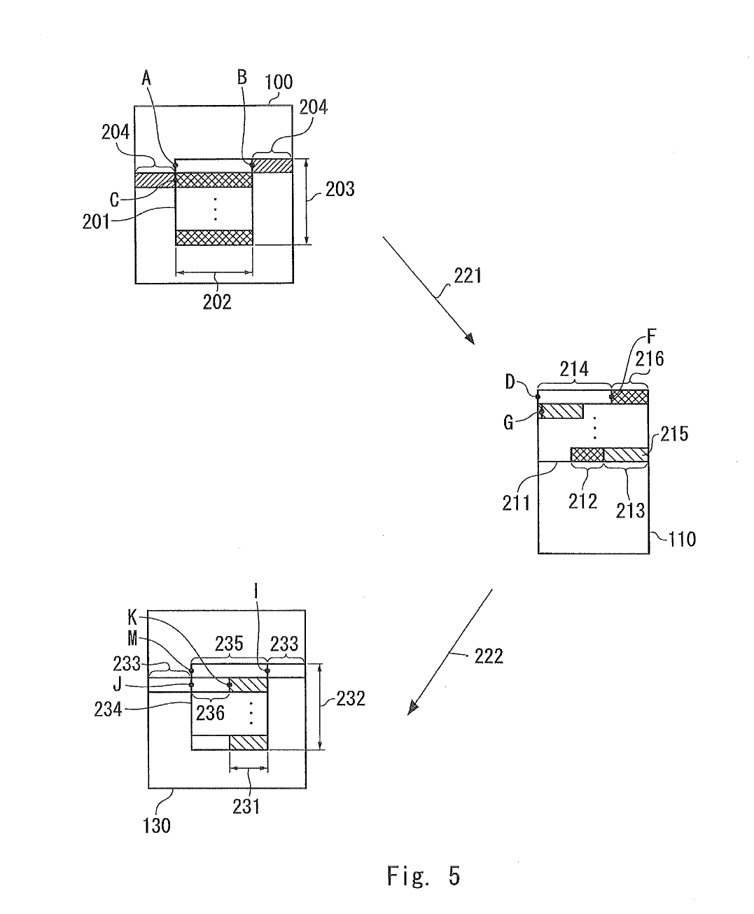

FIG. 5 is a view showing an external memory and an internal memory of a second exemplary embodiment.

In the second exemplary embodiment, the intra prediction process in an implementation of the H.264 decoder on the processor described in the patent literature 2 is analyzed. For the intra prediction process, pixels from neighboring MB of the same frame are utilized to predict pixels of the MB that is currently processed.

For the intra prediction process, one additional pixel is needed on left and upper sides, so overall data from 17 data rows have to be loaded. To minimize the number of ROI data transfer requests, which minimizes the number of ROI data transfer setup sequences, all data required to execute the intra prediction process on one MB is loaded with only one ROI data transfer request.

This results in a ROI data transfer request of 17 data rows with each 17 pixels from a memory area to a cache area. The architecture in patent literature 2 supports the fast data transfer burst modes: burst 1 with a transfer of 8 bytes per request in one clock cycle, burst 2 with a transfer of 16 bytes per request in two clock cycles, burst 4 with a transfer of 32 bytes per request in four clock cycles and burst 8 with a transfer of 64 bytes per request in eight clock cycles, which consume only one time the overhead for the initialization of a ROI data transfer request.

Therefore, the fastest way to read the 17-byte-data of one data row is to schedule a burst 4, which reads overall 32 bytes with one data transfer request in four clock cycles.

FIG. 5 shows an example of ROI data read and write transfer between a memory area and a cache area of the second exemplary embodiment. When using the extended ROI data transfer with the new parameter “cache_area_offset”, the ROI data read transfer 221 is done in the same way as the patent literature 2 by scheduling the burst 4 to transfer the ROI data area 201 with a height 203 of 17 data rows and a width 202 of 32 bytes in each data row from the memory area 200 starting at address A to the cache area 210 starting at address D.

However, after finishing of the intra prediction process on the MB, the ROI data write transfer 222 of this exemplary embodiment employs different ROI data transfer request parameter set from the ROI data transfer request parameter set employed in the patent literature 2. Here, only a data field with a height 203 of 16 rows times a width 231 of 16 bytes is written back. The rest of ROI data area of the 17 times 32 bytes, which has been read to the cache area, has been unchanged and therefore, the correct values are still stored in the memory area 230.

To be able to store back to the memory area only the last 16 bytes 213 of the 32 byte, which are loaded to the cache area for each data row, the new ROI data transfer request parameter “cache_area_offset” is utilized to skip the first 16 bytes 212 of each data row in the cache area. Therefore, the ROI data transfer request parameter “cache_area_offset” is defined to be equal to the difference of the horizontal size of the ROI data read and ROI data write transfer requests.

In this exemplary embodiment, the cache_area_offset is defined to be equal to 16.Further on, the new start address inside the memory area 201 and inside the cache area 211 for the ROI data write transfer has to be calculated. The new start address of the ROI data area 211 inside the cache area for the ROI data write transfer is calculated by adding one time the horizontal width 214 and the cache_area_offset 216 to the start address used for the ROI data read transfer. The horizontal width 214 of the ROI data read transfer is added for the first data row 214 which is not transferred back to the memory area. The cache_area_offset 216 is added because the first part of the second row holds unchanged data which is also not transferred from the ROI data write transfer.

For the memory area, the new memory_area_offset (from point Ito J+from J to K) for the ROI data write transfer is calculated by taking the memory_area_offset of the ROI data read transfer (204) and adding the cache_area_offset (212) to receive the new memory_area_offset. Further on, the new memory area start address for the ROI data write transfer is calculated by adding one time the horizontal width 235 and the new calculated memory_area_offset (204+236) between two transferred rows to the memory area start address used for the ROI data read transfer. The horizontal width 235 is added because of the first row in ROI data read transfer which is not transferred back to the memory area 230. The new calculated memory_area_offset (204+236) is added because it specifies the distance between the changed data areas of two consecutive rows. This new ROI data write transfer reduces the required bytes to be transferred by 16 times 16 bytes, which is 256 bytes in total, compared to the ROI data write transfer used in the patent literature 2, where 16 times 32 bytes are transferred back to the memory area.

In the ROI data write transfer of the patent literature 2, a burst 4 is utilized to transfer 32 bytes from a cache area to a memory area, which takes four clock cycles per row. Meanwhile, in the ROI data write transfer of the second exemplary embodiment, a burst 2 can be scheduled to store the 16 bytes back to the memory area, which takes two clock cycles per row. Therefore, the pure transfer time can be reduced by 32 clock cycles (16 times two clock cycles), where 8 bytes are transferred in one clock cycle.

### Third Exemplary Embodiment

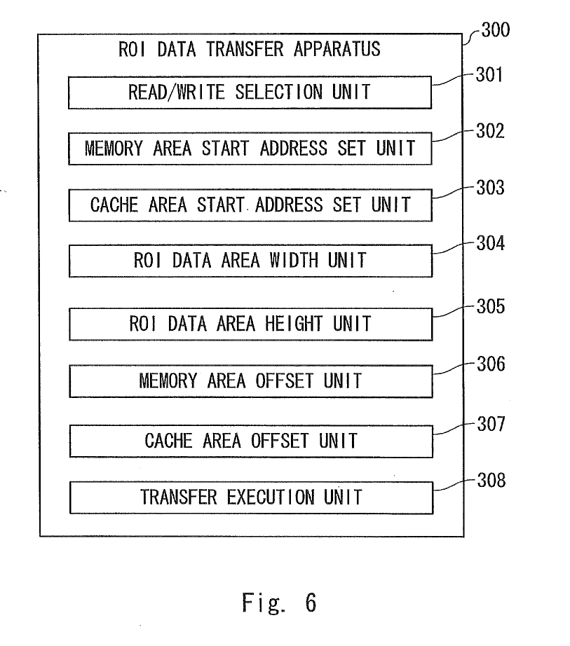

FIG. 6 shows a ROI data transfer apparatus for a third exemplary embodiment of the present invention. A memory controller 300 includes a read/write selection unit 301, a memory area start address set unit 302, a cache area start address set unit 303, a ROI data area width unit 304, a ROI data area height unit 305, a memory area offset unit 306, a cache area offset unit 307, and a transfer execution unit 308.

The read/write selection unit 301 firstly sets the correct transfer direction, and secondly selects the correct path for data transfer. The correct path is either from a memory area to a cache area or from cache area to memory area.

The memory area start address set unit 302 initializes the memory area start address to the first pixel of the first row of the ROI data area in the memory area used for the ROI data transfer.

The cache area start address set unit 303 initializes the cache area start address to the upper left position of the ROI data area in the cache area.

The ROI data area width unit 304 firstly initializes the ROI data area width parameter. Secondly, the ROI data area width unit 304 updates the start addresses for the next row in the memory area and cache area by adding for each row the ROI data area width to the start addresses.

The ROI data area height unit 305 firstly initializes the ROI data area height parameter. Secondly, the ROI data area height unit 305 decrements the height and compares the height with zero by using a loop counter.

The memory area offset unit 306 firstly initializes the memory_area_offset parameter. Secondly, the memory area offset unit 306 updates the memory area start address to the next row of the ROI data which is used in the transfer by adding the offset value to the current memory area start address.

For a ROI write transfer, the cache area offset unit 307 firstly initializes the cache_area_offset parameter and updates the memory_area_offset parameter. Secondly, the cache area offset unit 307 updates the cache area start address to the next row of the ROI data which is used in the transfer by adding the offset value to the current cache area start address.

The data transfer is performed in the transfer execution unit 308, which controls the transfer process by calling the tasks of the other units. The controlling of the ROI data area transfer is done by the transfer execution control task of the transfer execution unit 308. Firstly, the ROI data area transfer initialization is done by executing: the memory area initialization task of the memory area start address set unit 302, the cache area initialization task of the cache area start address set unit 303, the ROI data area width initialization task of the ROI data area width unit 304, the ROI data area height initialization task of the ROI data area height unit 305, the memory area offset initialization task of the memory area offset unit 306, the cache_area_offset initialization and memory_area_offset update task of the cache area offset unit 307 and the transfer direction set task of the read/write selection unit 301.

Next, the ROI data area height compare task of the ROI data area height unit 305 compares the height with zero by using a loop counter. If the height reaches zero, the ROI data transfer is completed. If the height does not reach zero, the read/write selection unit 301 selects the correct transfer path. Then, the data is transfered in the desired direction. After this, the memory area address update task from the ROI data area width unit 304 is called, which adds the ROI width to the memory area start address, followed by the memory area address update II task from the memory area offset unit 306, which adds the memory_{—} area_{—} offset to the memory area start address.

After this, the cache area address update task from the ROI data area width unit 304 is called, which adds the ROI width to the cache area start address, followed for the write direction by the cache area address update II task from the cache area offset unit 307, which adds the cache_area_offset to the cache area start address. Finally, the ROI data area height decrement task of the ROI data area height unit 305 decrements the ROI data area height variable by 1.

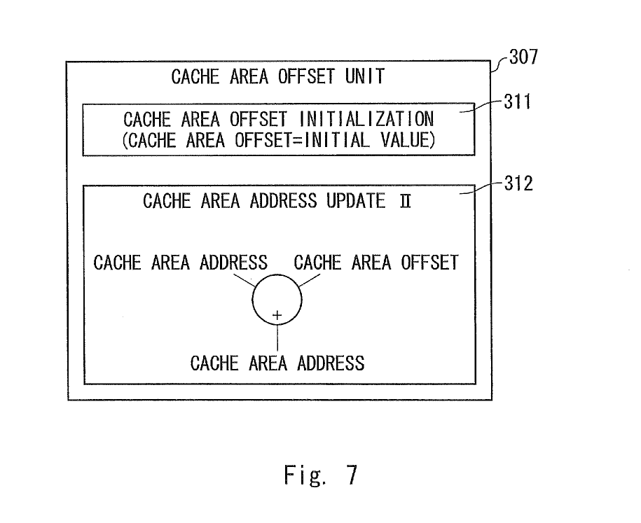

The difference between the ROI data transfer apparatus of the patent literature 2 and the memory controller 300 of the third exemplary embodiment is that for the ROI data write direction, the cache area offset unit 307 is added. FIG. 7 is a view showing a cache area offset unit of the third exemplary embodiment of the present invention. As shown in FIG. 7, the cache area offset unit 307 includes a cache area offset initialization and memory area offset update 311 and a cache area address update 312.

The cache area offset initialization and memory area offset update 311 includes a cache area offset initialization 321 and a memory area offset update 322, and initializes the cache area offset and updates the memory area offset. The cache area address update 312 updates the cache area address by adding the cache_area_offset value.

The exemplary embodiment can be used to transfer a non-continuous part of a data field from the cache area to the memory area, which is useful for the case where the transfer parameter for the horizontal size of a ROI data field is different between a ROI data read transfer and a ROI data write transfer. In this case, the new ROI data transfer request parameter cache_area_offset for the cache area can be used to deal with different horizontal sizes of the ROI data read transfer and ROI data write transfer between the cache area and the memory area. As a result, non-continuous part of a data field, which consists of areas of the same size which have to be transferred separated by areas of the same size which need not have to be transferred, can be transferred. This is done by setting the ROI data transfer request parameter cache_area_offset equal to the difference of the horizontal size of a ROI data read transfer and the horizontal size of a ROI data write transfer. As a result, the number of bytes to be transferred can be reduced, which enables to reduce data transfer bandwidth and time required for data transfer.

### INDUSTRIAL APPLICABILITY

The present invention is applicable to, for example, an information processing device and method.

### REFERENCE SIGNS LIST

1 information processing device
10 external memory
20 cache memory
30 memory controller
31 internal memory address updating unit
32 external memory address updating unit
33 first update unit
34 second update unit
35 third update unit
36 forth update unit
100, 130 memory area
101 ROI data area in the memory area
102 16 pixel width in the memory area
103 16 row height in the memory area
104 memory_area_{—} offset
105 data
110 cache area
111 ROI data area in the cache area
112 during processing non changed area of a first row
113 during process changed area of a first row
121 ROI data read transfer
122 ROI data write transfer
130 external memory
131 8 pixel width in the memory area
200, 230 external memory
201 ROI data area in the memory area
202 32 pixel width in the memory area
203 17 rows height in the memory area
204 memory_area_offset
210 cache area
211 ROI data area in the cache area
212 cache_area_offset in the cache area
213 changed part of 17th pixel row in the cache area
214 first pixel row in the cache area
216 unchanged part of second pixel row in the cache area
221 ROI data read transfer
222 ROI data write transfer
231 16 pixel in the memory area
235 horizontal width of ROI read transfer in the memory area
236 16 unchanged pixel in the memory area
300 memory controller
301 read/write selection unit
302 memory area start address set unit
303 cache area start address set apparatus
304 ROI data area width unit
305 ROI data area height unit
306 memory area offset unit
307 cache area offset unit
308 transfer execution unit
311 cache_area_offset initialization and memory_area_offset update
312 cache area address update
321 cache area offset initialization
322 memory area offset update
400, 430 memory area
401 ROI data area in the memory area
402 picture width
403 group of pixel with the size corresponding to one cache line
410 cache area
411 amount of data in external memory which corresponds to one cache line in the cache area
421 ROI data read transfer
422 ROI data write transfer
500, 530 memory area
501 ROI data area in the memory area
502 16 pixel width in the memory area
503 16 row height in the memory area
504 memory_area_offset
505 first pixel row in the memory area
506 second pixel low in the memory area
510 cache area
511 ROI data area in the cache area
512 first pixel row in the cache area
513 16th pixel row in the cache area
521 ROI data read transfer
522 ROI data write transfer
600, 630 memory area
601 ROI data area in the memory area
602 first data row in the memory area
603 second data row in the memory area
604 32 pixel width in the memory area
605 memory_area_offset
606 17 row height in the memory area
610 cache area
611 ROI data area in the cache area
612 second data row in the cache area
613 17th pixel row in the cache area
621 ROI data read transfer
622 ROI data write transfer
631 32 pixel width
632 16 rows height in the memory area

1. An information processing device, comprising:
an internal memory which is capable of performing processing faster than an external memory; and
a memory controller which controls data transfer between the internal memory and the external memory,
wherein the memory controller controls a first data transfer and a second data transfer, the first data transfer being data transfer from the external memory to the internal memory, and the second data transfer being data transfer from the internal memory to the external memory,
wherein the second data transfer transfers a part of data area transferred in the first data transfer, and data read out from a non-continuous area of the internal memory is transferred to the external memory in the second data transfer.

2. The information processing device according to claim 1, wherein the internal memory comprises a cache memory.

3. The information processing device according to claim 1, wherein the data transferred in the first data transfer and the second transfer comprises data of ROI (Region-of-interest).

4. The information processing device according to claims 1, further comprising:
a process circuit which performs a predetermined process by using the data written in the internal memory,
wherein in the second data transfer, only non-updated data which is not updated by the process circuit is written back to the external memory.

5. The information processing device according to claims 1,
wherein, in the first data transfer, data is read out from an updated first address of the external memory and is written in an updated second address of the internal memory, and in the second data transfer, data is read out from an updated third address of the internal memory and is written in an updated fourth address of the external memory,
wherein the memory controller includes an internal memory address updating unit which updates a second address and a third address, data written to the updated second address of the internal memory being continuous data, and data read out from the updated third address of the internal memory being non-continuous in the second data transfer.

6. The information processing device according to claim 4,
wherein, in the first data transfer, data is read out from an updated first address of the external memory and is written in an updated second address of the internal memory, and in the second data transfer, data is read out from an updated third address of the internal memory and is written in an updated fourth address of the external memory,
wherein the memory controller includes an internal memory address updating unit which updates a second address and a third address, data written to the updated second address of the internal memory being continuous data, and data read out from the updated third address of the internal memory being non-continuous in the second data transfer.

7. The information processing device according to claim 6, wherein the memory controller includes an external memory address updating unit which updates a first address and a fourth address, data started to be read out from the updated first address of the external memory in the first data transfer, and data started to be written back to the updated fourth address of the external memory in the second data transfer.

8. The information processing device according to claim 7, wherein the internal memory address updating unit comprises:
a first update means which updates the third address by a second data transfer size; and
a second update means which updates an updated third address by using a first offset.

9. The information processing device according to claim 8, wherein the external memory address updating unit comprises:
a third update means which updates the first address by the first data transfer size; and
a fourth update means which updates an updated the first address by using a second offset.

10. The information processing device according to claim 9, wherein the third update means updates the fourth address by a second data transfer size, and the fourth update means updates an updated fourth address by using the first offset and the second offset.

11. (canceled)

12. A data transfer method transferring data between an external memory and an internal memory, the internal memory being capable of performing a data transfer process faster than the external memory, the method comprising:
writing data to the internal memory from the external memory by a first data transfer; and
writing back data to the external memory from the internal memory by a second data transfer,
wherein a part of data area of the first data transfer is transferred in the second data transfer, and the second data transfer is a data transfer process from a non-continuous area of the internal memory to the external memory.

13. The data transfer method according to claim 12, wherein the internal memory comprises a cache memory.

14. The data transfer method according to claim 12, wherein the data transferred in the first data transfer and the second data transfer comprises data of ROI (Region-of-interest).

15. The data transfer method according to claim 12, further comprising:
performing a predetermined process by using the data written in the internal memory in the first data transfer,
wherein in the second data transfer, only non-updated data which is not updated by the performing step is written back to the external memory.

16. The data transfer method according to claims 12,
wherein, in the first data transfer, data is read out from an updated first address of the external memory and is written in an updated second address of the internal memory, and in the second data transfer, data is read out from an updated third address of the internal memory and is written in an updated fourth address of the external memory,
wherein a second address and a third address are updated to the updated second address and the updated third address,
wherein data written to the updated second address of the internal memory is continuous data, and data read out from the updated third address of the internal memory is non-continuous in the second data transfer.

17. The data transfer method according to claim 15,
wherein, in the first data transfer, data is read out from an updated first address of the external memory and is written in an updated second address of the internal memory, and in the second data transfer, data is read out from an updated third address of the internal memory and is written in an updated fourth address of the external memory,
wherein a second address and a third address are updated to the updated second address and the updated third address,
wherein data written to the updated second address of the internal memory is continuous data, and data read out from the updated third address of the internal memory is non-continuous in the second data transfer.

18. The data transfer method according to claim 17, wherein a first address and a fourth address are updated to the updated first address and the updated fourth address,
wherein data started to be read out from the updated first address of the external memory in the first data transfer, and data started to be written back to the updated fourth address of the external memory in the second data transfer.

19. The data transfer method according to claim 17, wherein the third address is updated by a second data transfer size, and an updated third address is updated by using a first offset.

20. The data transfer method according to claim 19, wherein the first address is updated by the first data transfer size, and an updated first address is updated by using a second offset.

21. The data transfer method according to claim 20, wherein the fourth address is updated by a second data transfer size, and updated fourth address is updated by using the first offset and the second offset.

22. (canceled)
